(19) United States
(12) Patent Application Publication
(10) Pub. No.: US 2002/0172871 A1
(43) Pub. Date: Nov. 21, 2002

(54) Thin film composite electrolytes, sodium-sulfur cells including same, processes of making same, and vehicles including same

(75) Inventor: Robert C. Schucker, The Woodlands, TX (US)

Correspondence Address: Jeffrey L. Wendt, 600 Town Center One, 1450 Lake Robbins Drive, The Woodlands, TX, 77380, US

(73) Assignee: Trans Ionics Corporation, The Woodlands, TX (US)

(21) Appl. No.: 10/125,711

(22) Filed: Apr. 18, 2002

Related U.S. Application Data
(60) Provisional application No. 60/291,996, filed on May 18, 2001.

(51) Int. Cl. H01M 6/18

(52) U.S. Cl. 429/304; 429/321; 427/58

(57) ABSTRACT

Thin film composite electrolyte structures are disclosed that are preferably ionically conductive but not electronically conductive and are therefore suitable for use in electrochemical cells, such as secondary batteries based on sodium and sulfur. Vehicles including the electrochemical cells are also disclosed.

### CROSS-REFERENCE TO RELATED APPLICATIONS

This application claims priority from copending provisional patent application serial No. 60/291,996, filed May 18, 2001, incorporated by reference herein.

### STATEMENT REGARDING FEDERALLY SPONSORED RESEARCH OR DEVELOPMENT

The United States Government has rights in this invention pursuant to Contract No. DE-FG03-01ER83317 between the United States Department of Energy and Trans Ionics Corporation.

### BACKGROUND OF THE INVENTION

1. Field of the Invention

The present invention relates to thin film composite electrolyte structures that are preferably ionically conductive but not electronically conductive and are therefore suitable for use in electrochemical cells, such as secondary batteries based on sodium and sulfur. The present invention also relates to a method for fabricating such electrolyte structures and electrochemical cells and vehicles employing the electrolytes.

2. Related Art

Solid ionically conductive electrolyte components are utilized in high temperature electrochemical cells, such as secondary batteries based on sodium and sulfur or sodium and a metal chloride. Such electrochemical cells are typically comprised of: a) a liquid anodic reactant; b) a liquid cathodic reactant; and c) a solid electrolyte component that separates the cathode from the anode and that is permeable by either ions from the anodic or cathodic reactants. For example, when the cell is a sodium-sulfur cell, the anodic reactant is liquid sodium, the cathodic reactant is liquid sulfur or a mixture of sulfur and sodium polysulfide, and the electrolyte component is typically comprised of materials such as beta double prime alumina (β″-alumina) or NASICON (Na₃Zr₂Si₂PO₁₂) that are permeable only by sodium ions.

The sodium-sulfur cell is a high temperature electrochemical device which comprises (1) a liquid sodium anodic reactant, (2) a liquid sulfur or mixed sulfur/polysulfide cathodic reactant and (3) a solid electrolyte, permeable only by sodium ions, that separates the cathode from the anode. A complete description of the fabrication and operation of sodium-sulfur cells can be found in the publication by J. L. Sudworth and A. R. Tilley entitled “The Sodium-Sulfur Battery”(Chapman and Hall, New York, 1985). The solid electrolyte used in sodium-sulfur cells is typically β″-alumina, but may be any other solid electrolyte that is permeable only by sodium ions. The cell reaction that produces power (discharge cycle) in this device is most generally given as

2Na+x S→Na₂Sₓ

Due to the high melting points of various components in the sodium-sulfur cell, the cell operating temperature is normally 300-350° C.

In order to function as a secondary battery, the anode compartment containing liquid sodium is connected to an external circuit through a current feeder, which is in turn in electrical contact with the liquid sodium, which itself is known to be a good electrical conductor. Due to the inherent lack of electrical conductivity of elemental sulfur, however, the cathode compartment must be filled with a conducting material such as graphite or fibrous metal, which is in turn connected to the external circuit. In order to function properly in a battery application, the solid electrolyte should be ionically, but not electrically, conductive.

In the vast majority of cases, the solid electrolyte is in the form of a self-supporting tube that is closed on one end forming a reservoir, such as that taught in U.S. Pat. No. 3,959,013 issued to Breiter, whose teachings are incorporated herein by reference. These tubes may typically have a wall thickness of 0.5-2 mm.

During the discharge cycle, sodium is oxidized (i.e. gives up an electron to form a sodium cation) at the anode and sodium ions migrate from the anode compartment through the solid electrolyte. Therefore, the reaction at the anode during discharge is

2Na⁰→2Na⁺+2e⁻

Simultaneously, the following reaction takes place at the cathode where elemental sulfur is reduced:

S⁰+2e⁻→S⁼

The flow of electrons through the external circuit from the anode to the cathode produces power to drive equipment such as electric motors.

A critical component of the sodium-sulfur battery is the solid electrolyte that allows only the transport of sodium cations while blocking the transport of sulfur anions. Since the original conception of the sodium-sulfur battery by Kummer and coworkers at Ford Motor Company in the late 1960s (Weber, N. and Kummer, J. T., “Advances in Energy Conversion Engineering”, ASME Conference, Florida, 1967, p. 913), the electrolyte of choice has been β″-alumina (Na₂O.5Al₂O₃), whose crystal structure was first determined by Yamaguchi and Suzuki (Bull. Chem. Soc. Japan, 41 (1968) 93). This has been true even though other materials, such as the material known under the trade designation “NASICON” (Na₃Zr₂Si₂PO₁₂), have shown promise [Goodenough, J. B. and H. Y. P. Hong, Mater. Res. Bull., 11 (1976) 203].

General techniques are known for fabrication of solid electrolyte structures (typically tubes or plates) from β″-alumina powder, and assembly of the resulting tubes or plates into a structure that is typically hermetically sealed for use in automotive and electrical utility load leveling applications; however, none of the concepts of the present invention have been anticipated described or suggested.

There are certain important requirements that the electrolyte component must meet in order to perform effectively in a high temperature electrochemical cell. One of these is high ionic conductivity; and, because ionic conductivity is inversely proportional to the thickness of the electrolyte component, it is desirable to make the electrolyte layer as thin as possible. Another important requirement is low electronic conductivity; and this is governed by the choice of electrolyte materials.

There are several conventional methods for fabricating such electrolyte components. For example, there are extensive teachings describing the fabrication of solid electrolyte structures (typically tubes or plates) from β″-alumina powder and assembly of the resulting tubes or plates into a structure that is typically hermetically sealed for use in automotive and electrical utility load leveling applications. While β″-alumina tubes can be prepared by isostatic compression of the powder, the preferred method of fabrication is electrophoretic deposition as described in U.S. Pat. Nos. 3,896,018; 3,896,019; 3,900,381; and 3,976,554, all of which are incorporated herein by reference. Further, U.S. Pat. No. 4,038,464, also incorporated herein by reference, teaches the use of fibrous mats in both electrode compartments to enhance the conductivity of the electrodes. The fabrication of β″-alumina in shapes other than tubes for greater cell efficiency is taught in U.S. Pat. No. 4,226,923, also incorporated herein by reference. U.S. Pat. No. 4,526,844, which is also incorporated herein by reference, teaches the use of the material known under the trade designation NASICON as the solid electrolyte in a sodium-sulfur battery. U.S. Pat. Nos. 4,048,390 and U.S. Pat. No. 4,123,566, whose teachings are also incorporated herein by reference, teach the use of metal aluminides as the cell housings to protect against corrosion. Similarly, U.S. Pat. No. 4,189,531, whose teachings are also incorporated herein by reference, teaches the protection of the aluminum housing by coating with a conducting polymer. More recently, Hitachi Corporation, in U.S. Pat. No. 6,329,099, has patented sodium-sulfur batteries useful for vehicles that are less susceptible to corrosion. Finally, U.S. Pat. Nos. 4,226,923; 4,568,502; 5,053,294; and 5,112,703, whose teachings are also incorporated herein by reference, teach methods for producing β″-alumina articles in shapes other than tubes for greater cell efficiency.

There are several inherent disadvantages to cells made by conventional methods. One disadvantage is that electrolytes made from materials such as β″-alumina have low ionic conductivity, because the electrolyte must be thick enough to also provide mechanical support. So, while it is generally known that thinner electrolytes have higher ionic conductivity, these unsupported electrolyte tubes can typically not be optimized for high conductivity because of the limitations of their mechanical strength.

Another disadvantage of conventional methods results from forming the electrolyte as tubes on mandrels (typical of the electrophoretic deposition method), because there is a limit on the minimum diameter of the tube and also on its maximum length. This, in turn, limits the surface area to volume ratio, and thus the energy density, of the resulting electrochemical cell. For example, sodium-sulfur cells made by conventional techniques have relatively low surface area to volume ratios; and, consequently, they have lower energy densities than desired.

One approach to mitigating these disadvantages is to support the solid electrolyte as a thin film on a suitable microporous support. U.S. Pat. No. 4,244,986, whose teachings are also incorporated herein by reference, teaches the application of a precursor to β″-alumina (in the form of a sol) onto supports such as α-alumina, mullite or zirconium oxide. One concern with respect to this approach is the difference in the Coefficient of Thermal Expansion (CTE) between β″-alumina (8.6×10⁻⁶/° C.) and the preferred supports α-alumina (8.2×10⁻⁶/° C.), zirconium oxide (8.2×10⁻⁶/° C.) and especially mullite (5.2×10⁻⁶/° C.). A second concern is that none of the listed refractory ceramic supports are electrically conductive, thereby limiting the configuration of a sodium-sulfur cell made by this process to one in which the anode reactant is on the support side.

While the aforementioned '844 patent suggests that NASICON can also be used as the solid electrolyte in a sodium-sulfur cell, there are no actual examples showing that a thin film composite of such a material was ever made. This may be because of the significant mismatch in CTE between NASICON (˜1×10⁻⁶/° C.) and most microporous substrates.

U.S. Pat. No. 5,059,497, whose teachings are also incorporated herein by reference, teaches the fabrication of a composite, ion-conductive electrolyte member comprised of a first layer of an ion conductive material such as β″-alumina, and a second, or substrate layer, comprised of a material selected from aluminum silicon carbide, doped tin oxide, graphite, or composites, compounds, mixtures, and/or combinations of these materials. A preferred material is selected from the titanium dioxide family as taught be U.S. Pat. Nos. 4,422,917 and 3,985,575 (tantalum or niobium-doped TiO). According to the '497 patent, the first layer is much thinner than the second in order to provide higher ionic conductivity and the second layer is substantially thicker to provide suitable mechanical support.

The first layer can be applied by, among other techniques, electrophoretic deposition. The variance of the CTE between the first and second layers is less than about 25%, and preferably less than 10%. The electrical resistivity of titania (10¹⁰ Ωcm), however, is extremely high. Therefore, the cell can only be practically operated with the titania support in contact with the anode (liquid sodium), which is known to be a good electrical conductor. Attempts to operate with the titania support in contact with the cathode (liquid sulfur/sodium polysulfide, which is known to be a very poor electrical conductor) would result in a much lower efficiency for the cell. Therefore, one important limitation of the '497 patent is that it teaches the use of a single electrolyte layer which is chosen first and then the selection of a substrate that has a very similar CTE, even if the other properties of that substrate are less than optimal. Thus, one cannot choose the optimum electrolyte/substrate combination, because of a probable mismatch in the resulting CTEs.

While conventional methods have provided solid ion-conductive electrolyte components for electrochemical cells with varying commercial success, there is still a need in the art for solid ion-conductive electrolytes with improved ion-conductive properties and improved mechanical properties that can withstand the stresses associated with wide temperature swings. Electrochemical cells and vehicles incorporating such cells are also in demand. There is also a need in the art for improved methods of making solid ion-conductive electrolytes.

### SUMMARY OF THE INVENTION

In accordance with the present invention, electrolyte structures, electrochemical cells incorporating same, and vehicles incorporating such cells, as well as methods of making such electrolytes, are presented which overcome many of the drawbacks of previously known devices and methods.

In accordance with a first aspect of the present invention, there is provided an electrochemical cell comprising: a) an anode containing at least one anodic reactant; b) a cathode containing at least one cathodic reactant; and c) a composite ion-conductive electrolyte structure comprised of: i) a first layer, preferably thin-film in nature, comprised of a mixture of two or more chemically distinct compounds, at least one of which is ion-conductive, and ii) a second layer to which is bonded said first layer, said second layer being comprised of any refractory support structure having an effective microporosity that will allow an effective flow of anodic or cathodic reactants to said first layer, wherein said first layer and said second layer have a coefficient of thermal expansion within about 5%, or less, of each other.

In preferred electrochemical cell embodiments of the present invention the refractory support structure is electrically conductive. In other preferred electrochemical cell embodiments of the present invention the electrochemical cell is a sodium-sulfur cell wherein the anodic reactant comprises liquid sodium and the cathodic reactant comprises a mixed sulfur/sodium polysulfide.

In accordance with a second aspect of the present invention there are provided composite electrolyte structures, preferably thin-film in nature, suitable for use in electrochemical cells, which composite electrolyte structures are comprised of a first layer comprised of a mixture of two or more chemically distinct compounds, at least one of which is ion-conductive, and ii) a second layer to which is bonded said first layer, said second layer being comprised of a refractory support structure having an effective microporosity that will allow a flow of anodic or cathodic reactants to said first layer, wherein said first layer and said second layer have a coefficient of thermal expansion within about 5%, or less, of each other.

As used herein the term “thin-film” means a uniform or nonuniform thickness layer or coating, preferably uniform thickness, of an ionically conductive material, preferably less than 100 microns thick, more preferably less than 50 microns thick. The term β″-alumina preferably refers sodium β″-alumina as defined by the formula Na₂OₓAl₂O₃, where x can vary from 5 to 11.

In accordance with a third aspect of the present invention, methods for producing the composite electrolyte structures of the second aspect of the invention suitable for use in electrochemical cells of the third aspect are provided, which processes comprise: a) selecting a microporous support substrate comprised of graphite or silicon carbide or one or more transition metal oxides or transition metal mixed oxides or mixtures thereof; b) applying to said substrate a mixture of at least two electrolyte compositions, at least one of which is conductive for a predetermined ion, said mixture being formulated to have, when dried and sintered, approximately the same average coefficient of thermal expansion as the microporous substrate; c) drying said mixture to form a dried mixture; and d) firing and sintering the dried mixture for an effective amount of time and at an effective temperature to produce a substantially dense composite electrolyte layer on the substrate. Preferably one or more of the ingredients of the mixture, and thus the composite electrolyte are conductive with respect to sodium ions. Preferably one or more of the ingredients of the composite electrolyte component are selected from β″-alumina and Na₃Zr₂Si₂PO₁₂.

In accordance with a fourth aspect of the present invention, methods are provided for making thin-film electrolyte structures and compositions comprising an ionically conductive layer (preferably comprising materials selected from the group consisting of β″-alumina, Na₃Zr₂Si₂PO₁₂) and a porous substrate (preferably selected from the group consisting of yttria stabilized zirconia, titanium oxide selected from Ti_{N}O_{2N-1} where N ranges from 4-10, tantalum doped-titania, and niobium-doped titania, α-alumina and combinations thereof), the methods comprising the steps of:

a) depositing a composition comprising a precursor of the porous substrate via a deposition process onto an electrically conductive, oxidizable substrate material (preferably comprising a material that can be burned in an atmosphere comprising oxygen, preferably air);

b) applying, via electrophoretic deposition, a composition comprising a presursor to the ionically conductive layer to at least a portion of the composition comprising a presursor of the porous substrate, preferably without intermediate drying of the composition comprising a precursor of the porous substrate, thus forming a green structure and composition; and

c) drying and sintering the green structure and composition in an atmosphere comprising oxygen to remove substantially all of the electrically conductive, oxidizable substrate material.

Preferred methods in accordance with the fourth aspect are those wherein the electrically conductive, oxidizable substrate material is graphite; methods wherein the poroous substrate comprises α-alumina and is less than 500 microns in thickness; and methods wherein the ionically conductive layer comprises β″-alumina and is less than 200 microns in thickness, more preferably less than 50 microns in thickness. The phrase “porous substrate” means a material having a porosity ranging from about 20 to about 60 percent. Preferably, the drying and sintering of step (c) occur at temperatures ranging from about 1200° C. to about 1650° C., with lower temperatures being preferred due to lower cost. The atmosphere comprising oxygen is preferably air, but can be any fluid having oxygen in sufficient amount to oxidize the substrate material. Oxygen-depleted air and oxygen-enriched air may be employed, as well as bicomponent mixtures such as argon/oxygen and the like. Industrially pure oxygen, as from a cryogenic, adsorption, or membrane separation unit may be employed, as well as cylinder oxygen.

Electrolyte products made by the methods of the fourth aspect of the invention are considered a fifth aspect of the invention. The products preferably have a shape selected from the group consisting of cylindrical solid rod, cylindrical hollow tube, corrugated sheet, flat plate, I-beam, triangular rod, prismatic rod, polygonal rod, saddle, spherical, multi-sided pyramidal, and any other shape where β″-alumina can reasonably be coated onto α-alumina using an oxidizable substrate. Electrochemical cells, such as sodium-sulfur cells, employing an electrolyte of the fifth aspect are considered a sixth aspect of the invention.

Another aspect of the invention is a transportation vehicle comprising an electrochemical cell of the invention. As used herein the term “transportation vehicle” includes automobiles, trucks, buses, trains, boats, ships, barges, submarines, airplanes, and the like.

Other aspects and advantages of the invention will become apparent after reading the following description of preferred embodiments.

### BRIEF DESCRIPTION OF THE DRAWINGS

FIG. 1 is a cross-section of one embodiment of an electrochemical cell of the invention, including a thin-film composite electrolyte embodiment of the invention;

FIG. 2 is a perspective view of a second embodiment of a supported thin-film composite electrolyte of the invention;

FIG. 3 is a perspective view of a third embodiment of a supported thin-film composite electrolyte of the invention;

FIG. 4 is a side-sectional elevation view of a preferred embodiment of an electrochemical cell of the present invention, illustrating the cell connected to an electric motor; and

FIG. 5 is a side-sectional elevation view of a transportation vehicle of the invention employing an electrochemical cell of the invention.

### DESCRIPTION OF PREFERRED EMBODIMENTS

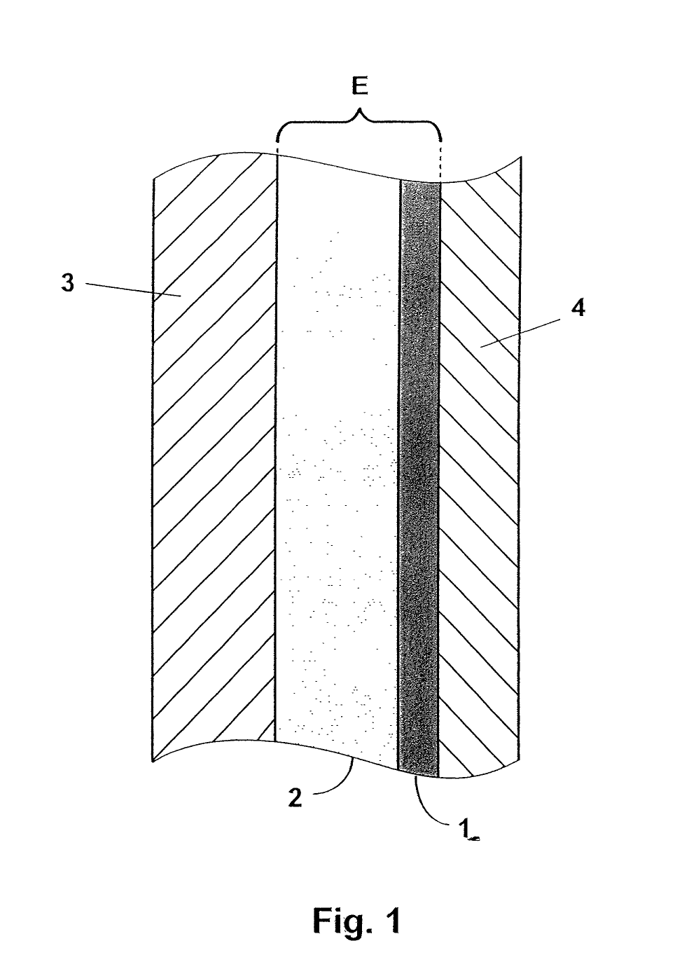

The present invention encompasses thin-film composite electrolyte structures such as illustrated in FIG. 1, which are primarily suitable for use in an electrochemical cell, particularly those that operate are relatively high temperatures. The most preferred electrochemical cell is a sodium-sulfur cell wherein liquid sodium is the anodic reactant and a mixed sulfur/sodium polysulfide is the cathodic reactant. Referring now to FIG. 1, one preferred electrochemical cell is illustrated which is comprised of a cathode 3 comprised of a cathodic reactant; an anode 4 which is comprised of an anodic reactant; and a thin-film composite electrolyte structure E which is comprised of a first component layer 1 and a second component layer 2. As previously mentioned, the preferred anodic reactant comprises liquid sodium and the preferred cathodic material comprises a mixed sulfur/sodium polysulfide material.

In one preferred thin-film electrolyte embodiment, first component layer 1 is comprised of two distinct chemical compositions or compounds, at least one of which will be conductive with respect to a desired ion. In the case where the electrochemical cell is a sodium-sulfur battery, this first component layer will be conductive with respect to sodium ions. Second component layer 2 is comprised of a substrate, or support material that, for the case of the first preferred electrochemical cell embodiment, will be electrically conductive. It is to be understood that in some embodiments the composite electrolyte structure of the present invention can be designed for use in devices other than electrochemical cells, and thus the second component layer may not be electrically conductive. See the discussion, infra, regarding the fourth and fifth aspects of the invention. Such other devices include oxygen separation systems. In any event, it is desirable that the composite electrolyte structures of the present invention be designed for high temperature application, especially where relatively large temperature swings take place. Thus, it is important that the composite electrolyte layer 1 have a CTE that is substantially the same as that of the second, or substrate layer 2. For the purposes of this invention the term “substantially the same” with respect to the two CTEs means that they are within 5 percent, preferably within 3 percent, and more preferably within 1 percent of each other.

For electrolyte embodiments of the second aspect of the invention, where the electrolyte comprises a mixture of two or more chemical components, it is desirable to select from materials that have a wide range of CTEs. Fortunately, a number of materials identified to date meet this criterion. Preferred components of the electrolyte mixture include the material known under the trade designation NASICON (Na₃Zr₂Si₂PO₁₂), having a CTE of about 1×10⁶/° C., and/or β″-alumina, having a CTE of about 8.6×10⁻⁶/° C., both of which have been shown to selectively conduct sodium ions. Other components may include, but are not limited to, such materials as zirconia (ZrO₂) having a CTE of ˜8.2×10⁻⁶/° C., yttria stabilized zirconia (YSZ) having a CTE of ˜10.3×10⁻⁶/° C., and magnesia (MgO) having a CTE of 13×10⁻⁶/° C., all of which may act as fillers. Therefore, by way of example on a weight basis, a mixture comprising 93.4 percent β″-alumina and 6.6 percent of Na₃Zr₂Si₂PO₁₂ would have a CTE of approximately 8.1×10⁻⁶/° C. and could be deposited onto graphite (8.1×10⁻⁶/° C.). Similarly, a mixture of 46.1 percent β″-alumina and 53.9 percent Na₃Zr₂Si₂PO₁₂ would have a CTE of approximately 4.5×10⁻⁶/° C. and could be deposited onto silicon carbide (4.5×10⁻⁶/° C.), thereby providing an almost perfect match between the CTE of the substrate and that of the thin film electrolyte.

An ancillary benefit to the use of a mixture of β″-alumina and a Na₃Zr₂Si₂PO₁₂ is that the final sintering can be carried out at a lower temperature (1000-1250° C., rather than the 1600° C. usually needed to fully densify β″-alumina articles) because Na₃Zr₂Si₂PO₁₂ sinters at a lower temperature than β″-alumina [Shimizu, Y. and T. Ushijima, Solid State Ionics, 132 (2000), 143-148] and acts as a binder to hold the matrix together. This results in substantial energy savings for the manufacture of the supported electrolytes by the disclosed invention.

In electrolytes of the second aspect of the invention, the second component layer 2 can be comprised of any high temperature material suitable for the intended application of the resulting composite electrolyte component. Nonlimiting examples of materials that can be used for the substrate include silicon carbide, graphite, pure metals such as nickel, metal alloys including stainless steels, transition metal oxides and transition metal mixed oxides wherein the transition metal is selected from the group consisting of Groups IIIA (Sc, Y, La), IVA (Ti, Zr, Hf), VA (V, Nb, Ta), VIA (Cr, Mo, W), VIIA (Mn, Re), VIIIA (Fe, Co, Ni, etc.), IB (Cu, Ag, Au), and IIB (Zn, Cd, Hg) of the Periodic Table of the Elements, inclusive of mixtures and alloys thereof. Preferred materials for the substrate include, but are not limited to, graphite and silicon carbide, which have CTEs of (8.1×10⁻⁶/° C.) and (4.5×10⁻⁶/° C.) respectively.

In the case where the intended application of the composite electrolyte component of the present invention is an electrochemical cell, this second, or substrate layer, will be electrically conductive. Metals and graphite are electrically conductive materials.

The microporous substrate component may be of any shape, including but not limited to, flat plates, tubular structures or monolithic structures, depending on the intended final use of the system. The thin-film composite electrolyte component is applied to the substrate by any suitable means. Nonlimiting means for applying the electrolyte material to the substrate include: a) electrophoretic deposition; b) electrolytic deposition, c) chemical vapor deposition; d) plasma spray deposition; and e) sputtering. The more preferred means for applying the electrolyte component to the substrate component is by electrophoretic deposition, electrolytic deposition or chemical vapor deposition, with electrophoretic deposition being the most preferred. When fully densified the thin-film composite electrolyte component 1 will have a thickness from about 1 to 500 microns, preferably from about 1 to 200 microns, and more preferably from about 1 to 50 microns.

A preferred method for making the composite electrolyte structures of the second aspect of the present invention, particularly with respect to sodium-sulfur cells, comprises: a) selecting a suitable microporous, electrically conducting substrate component; b) applying to said microporous substrate component a mixture of at least two electrolyte compounds, at least one of which has a selective conductivity for sodium ions, said mixture being formulated to have substantially the same average coefficient of thermal expansion as the microporous substrate component, c) drying the mixture to form a dried mixture; and d) sintering the dried mixture for an effective amount of time and at an effective temperature to create a substantially dense, thin-film composite electrolyte component.

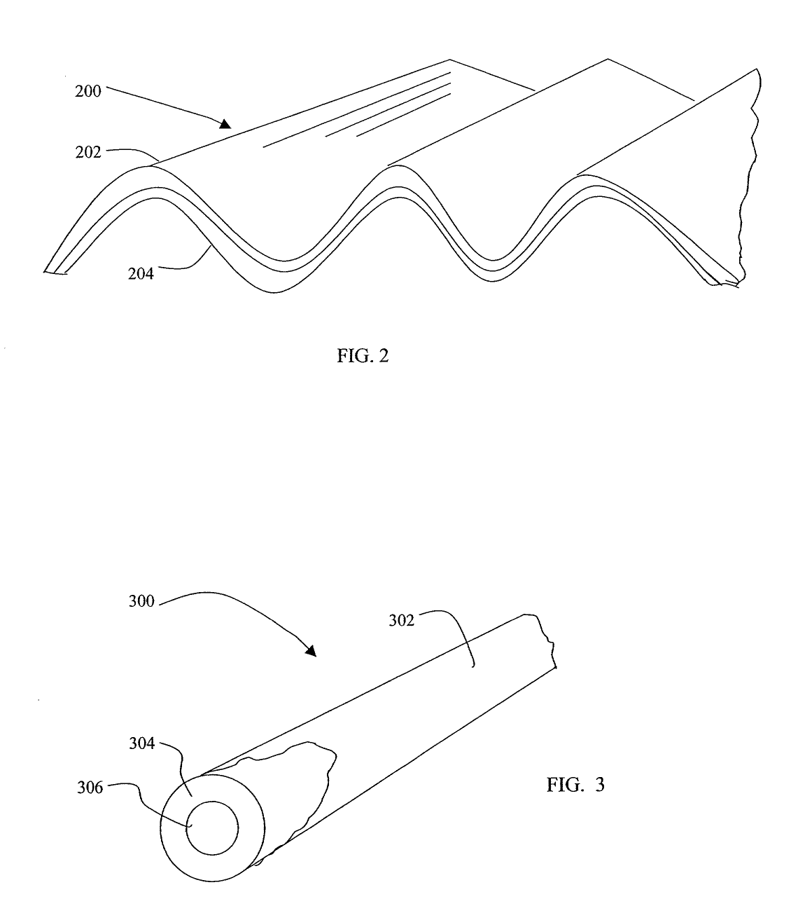

FIG. 2 illustrates a perspective view of a second embodiment 200 of a supported thin-film composite electrolyte of the invention. As may be seen the shape is corrugated, which in some electrochemical cells will improve the efficiency of the cell. Layer 202 comprises the ionically conductive layer, while layer 204 comprises the substrate, which may be either electrically conductive or insulating. The layers are intentionally illustrated as being non-uniform in thickness, although uniform thickness is preferred, and the thickness of both layers is exaggerated. In one embodiment, layer 202 preferably comprises a mixture of β″-alumina and Na₃Zr₂Si₂PO₁₂, while layer 204 preferably comprises graphite. In another preferred embodiment, layer 202 comprises β″-alumina and layer 204 comprises α-alumina.

FIG. 3 illustrates a perspective view, with a portion broken away, of a third embodiment 300 of a supported thin-film composite electrolyte of the invention. As may be seen the shape is a hollow rod. Layer 302 comprises the ionically conductive layer, while hollow rod 304 comprises the substrate, which may be either electrically conductive or insulating. The layers are intentionally illustrated as being non-uniform in thickness, although uniform thickness, particularly for layer 302, is preferred, and the thickness of both layers is exaggerated. In one embodiment, layer 302 preferably comprises a mixture of β″-alumina and Na₃Zr₂Si₂PO₁₂, while rod 304 preferably comprises graphite. In another preferred embodiment, layer 302 comprises β″-alumina and rod 304 comprises α-alumina.

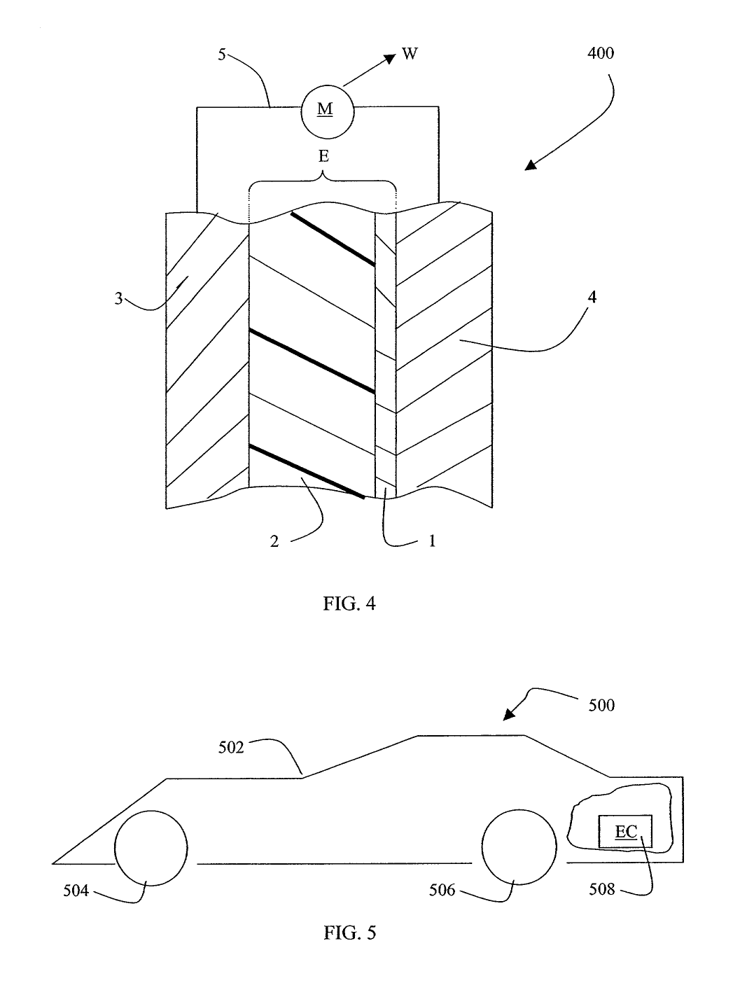

FIG. 4 illustrates a side-sectional elevation view, not to scale, of a preferred embodiment 400 of an electrochemical cell of the present invention, illustrating the cell connected to an electric motor M via an electrical conductor cable 5 to produce work W in a discharge cycle. The electrochemical cell is other wise similar to the structure of FIG. 1. Note in these embodiments that layer 2 must be electrically conductive. Preferably, a plurality of cells of the invention are connected in parallel or series to motor M.

FIG. 5 is a side-sectional elevation view of a transportation vehicle 500 of the invention, in this case an automobile having a body 502, and wheels 504 and 506. An electrochemical cell EC of the invention is depicted, while the motor is not illustrated. It should be noted that the vehicle dictates the number of wheels. In the case of vehicles such as automobiles, the vehicle may have three or four wheels; trucks and buses will typically have four or more. It may be possible to devise levitation vehicles requiring no wheels, as in certain trains, using the electrochemical cells of the invention. Water vehicles of course will not require wheels, although boats with wheels are known, which allow the boats to be driven on terra firma. Electrochemical cells of the invention may provide supplemental motive power to a conventional internal combustion engine, steam engine, or other primary engine. Alternatively, the electrochemical cells of the invention may be employed only for emergency power, or to power accessories, such as lighting.

As previously mentioned, thin-film composite electrolyte structures made in accordance with the present invention that have electrically conductive second layers are suitable for use in electrochemical cells such as sodium-sulfur batteries, although they are also suitable for use in sodium-metal chloride batteries. Such batteries will ultimately have many uses, such as for electric vehicles, electric power load leveling and the production of metallic sodium.

In one embodiment of the present invention, electrically conductive substrate components are assembled into an appropriate housing before applying, preferably by electrophoretic deposition, the composite electrolyte component. For example, in a tubular configuration, microporous tubes of the substrate component can be sealed into two non-porous end sheets that have been pre-drilled to provide passageways through the end sheets and counter-bored to accept the microporous tubes, said tubes forming a plurality of parallel tubes through which liquid can flow from one end sheet to the other. For further example, in the monolithic configuration, parallel longitudinal channels, which may be round, triangular, square, pentagonal, hexagonal or any other multi-sided structure, are formed as an integral part of the structure, said channels being as small as practical with a wall thickness between channels also being as small as practical.

In either embodiment, the substrate component may be sealed into a housing, which housing provides a means by which to separate the liquid sodium anode from the mixed sulfur/sodium polysulfide cathode. The seals and housings that are used may be any that are compatible with the components in the system at the temperatures under which the cell is operated. Such seals and housings are known to those having ordinary skill in the art so that no further elaboration herein is necessary.

Alternatively, the thin-film composite electrolyte component can be fabricated prior to the assembly of the substrates into a housing.

In certain preferred embodiments, a flow of electrode reactants can be provided through both sides of the cell by use of an appropriately sealed module design, thus comprising an electrochemical membrane flow reactor. In the embodiment illustrated in FIGS. 1 and 4 hereof, the sulfur/sodium polysulfide cathodic reactant mixture 3 is in contact with the substrate 2 and the sodium anodic reactant mixture 4 is in contact with the thin-film composite electrolyte component 1.

As previously mentioned, the most preferred method of applying the electrolyte material to the substrate is by electrophoretic deposition. In the electrolyte embodiments having at least two chemical components, electrophoretic deposition typically and preferably involves immersing a microporous substrate, such as a hollow graphite rod, into a coating suspension containing the selected mixture of electrolytes. The suspension of electrolyte ingredients can be prepared according to the teachings outlined in any one or more of U.S. Pat. Nos. 3,896,018; 3,896,019; 3,900,381; and 3,976,554, all of which are incorporated herein by reference. During the coating process, one electrical contact is made to the electrically conductive microporous substrate and the other is made to the vessel holding the suspension. According to the teachings of U.S. Pat. No. 3,900,018, an initial DC electric field of 100-10,000 volts per centimeter is applied from the power source across the microporous substrate as the positive electrode and across the vessel as the negative electrode. Voltage is applied until the desired coating thickness has been reached. The '018 patent also teaches a coating time of less than 150 seconds.

Following the electrophoretic deposition step, the resulting “greenware”, comprising the porous electrolyte coating on the microporous substrate, is thoroughly dried in air for up to 24 hours prior to subsequent processing. According to the teachings of the '018 and '019 patents, the “greenware” is then fired at an effective temperature and for an effective amount of time to produce the desired densified electrolyte component. An effective temperature will typically be in the range of about 1000° C. and 1825° C., preferably from about 1000° C. to about 1650° C., more preferably from about 1000° C. to about 1400° C., and most preferably from about 1000° C. to about 1300° C. An effective amount of time will typically range from about 10 minutes to 120 minutes, preferably from about 10 minutes to about 60 minutes. In accordance with the fourth aspect of the present invention, methods are provided for making thin-film electrolyte structures and compositions comprising a first layer comprising β″-alumina and a second layer comprising α-alumina, the methods comprising the steps of depositing a composition comprising α-alumina via a deposition process onto an electrically conductive, oxidizable substrate material. Preferably, the oxidizable substrate comprises a material that can be burned in an atmosphere comprising oxygen, preferably air, thus forming a composition comprising α-alumina on the oxidizable substrate. Thereafter, a composition comprising β″-alumina is exposed to at least a portion of the composition comprising α-alumina, and β″-alumina is deposited via electrophoretic deposition, preferably without intermediate drying of the composition comprising α-alumina, thus forming a green structure. Finally, the green structure is dried and sintered in an atmosphere comprising oxygen to remove substantially all of the electrically conductive, oxidizable substrate material.

Preferred methods in accordance with the fourth aspect are those wherein the electrically conductive, oxidizable substrate material is graphite; methods wherein the α-alumina is less than 500 microns in thickness, preferably less than 200 microns, more preferably less than 100 microns; and methods wherein the β″-alumina is less than 200 microns in thickness, more preferably less than 50 microns in thickness. Preferably, the drying and sintering occur at temperatures ranging from about 1200° C. to about 1650° C., with lower temperatures being preferred to lower expense. The atmosphere comprising oxygen is preferably air, but can be any fluid having oxygen in sufficient amount to oxidize the substrate material. Oxygen-depleted air and oxygen-enriched air may be employed, as well as bicomponent mixtures such as argon/oxygen and the like. Industrially pure oxygen, as from a cryogenic, adsorption, or membrane separation unit may be employed, as well as cylinder oxygen.

Electrolyte products made by the methods of the fourth aspect of the invention are considered a fifth aspect of the invention. The products preferably have a shape selected from the group consisting of cylindrical solid rod, cylindrical hollow tube, corrugated sheet, flat plate, I-beam, triangular rod, prismatic rod, polygonal rod, saddle, spherical, multi-sided pyramidal, and any other shape where β″-alumina can reasonably be coated onto α-alumina using an oxidizable substrate. Electrochemical cells, such as sodium-sulfur cells, employing an electrolyte of the fifth aspect are considered a sixth aspect of the invention.

In a tubular array configuration, with any tube inside diameter greater than about ⅛″, the electrolyte coating can either be deposited on the inside wall or on the outside wall of a tube. For tubes having inside diameters less than ⅛″, including microporous rods, the coating is preferably deposited on the outside wall.

Thin-film composite electrolytes made by the processes of the present invention can be sealed into a variety of housings known to one of ordinary skill in the art in order to form a working sodium-sulfur cell, such as aluminum housings, glass housings, and the like. U.S. Pat. No. 4,189,531, whose teachings are also incorporated herein by reference, teaches the protection of the aluminum housing by coating with a conducting polymer. U.S. Pat. Nos. 4,048,390 and U.S. Pat. No. 4,123,566, whose teachings are also incorporated herein by reference, teach the use of metal aluminides as the cell housings to protect against corrosion. U.S. Pat. No. 4,038,464, also incorporated herein by reference, teaches the use of fibrous mats in both electrode compartments to enhance the conductivity of the electrodes. The fabrication of β″-alumina in shapes other than tubes for greater cell efficiency is taught in U.S. Pat. No. 4,226,923; 4,568,502; 5,053,294; and 5,112,703, whose teachings are incorporated herein by reference.

This various aspects of the invention have been described with many advantages in mind, but certainly those skilled in the art will conceive of insubstantial variations and modifications to the structures and methods described herein, which are to be considered laying within the fair boundaries of the appended claims.

What is claimed is:

1. A thin film composite electrolyte structure suitable for use in electrochemical cells, which composite electrolyte structure is comprised of a first layer comprised of a mixture of two or more chemically distinct compounds, at least one of which is ion-conductive, and ii) a second layer to which is bonded said first layer, said second layer being comprised of a refractory support structure having an effective microporosity that will allow a flow of anodic or cathodic reactants to said first layer, wherein said first layer and said second layer have a coefficient of thermal expansion within about 5 percent, or less, of each other.

2. The thin film composite of claim 1 wherein one or more of the ingredients of the composite thin-film electrolyte component are conductive with respect to sodium ions.

3. The thin film composite of claim 2 wherein at least one of the ingredients of said first layer is selected from the group consisting of β″-alumina, Na₃Zr₂Si₂PO₁₂, zirconia, yttria stabilized zirconia, and magnesia.

4. The thin film composite of claim 3 wherein at least one of the ingredients of said first layer is selected from β″-alumina and Na₃Zr₂Si₂PO₁₂.

5. The thin film composite of claim 1 wherein said second layer is electrically conductive.

6. The thin film composite of claim 1 wherein said second layer is selected from the group consisting of silicon carbide, graphite, pure metals, metal alloys, and transition metal oxides of transition metals selected from groups IIIA, IVA, VA, VIA, VIIA, VIIIA, IB, and IIB of the Periodic Table of the Elements.

7. A method for producing a composite thin-film electrolyte structure suitable for use in high temperature electrochemical cells, which process comprises:
a) selecting a microporous refractory support substrate; b) applying to said substrate a mixture of at least two electrolyte compositions, at least one of which is conductive with respect to a predetermined ion, said mixture being formulated to have, when dried and sintered, approximately the same average coefficient of thermal expansion as the microporous substrate; c) drying said mixture; and d) sintering said mixture for an effective amount of time and at an effective temperature to produce a substantially dense composite electrolyte layer on said substrate.

8. The method of claim 7 wherein one or more of the ingredients of the mixture are conductive with respect to sodium ions.

9. The method of claim 8 wherein at least one of the ingredients of said mixture is selected from the group consisting of β″-alumina, Na₃Zr₂Si₂PO₁₂, zirconia, yttria stabilized zirconia, and magnesia.

10. The method of claim 9 wherein at least one of the ingredients of said mixture is selected from the group consisting of β″-alumina and Na₃Zr₂Si₂PO₁₂

11. The method of claim 7 wherein said second layer is selected from the group consisting of silicon carbide, graphite, pure metals, metal alloys, and transition metal oxides of transition metals selected from groups IIIA, IVA, VA, VIA, VIIA, VIIIA, IB, and IIB of the Periodic Table of the Elements, and mixtures and combinations of two or more of these.

12. An electrochemical cell comprising: a) an anode containing at least one anodic reactant; b) a cathode containing at least one cathodic reactant; and c) a composite ion-conductive electrolyte structure comprised of: i) a first layer comprised of a mixture of two or more chemically distinct compounds, at least one of which is ion-conductive; and ii) a second layer to which is bonded said first layer, said second layer being comprised of a refractory support structure having an effective microporosity that will allow a flow of anodic or cathodic reactants to said first layer, wherein said first layer and said second layer have a coefficient of thermal expansion within about 5%, or less, of each other.

13. The electrochemical cell of claim 12 which is a sodium-sulfur cell wherein the anodic reactant comprises liquid sodium and the cathodic reactant comprises a mixture of sulfur and sodium polysulfide.

14. The electrochemical cell of claim 12 wherein at least one of the ingredients of said first layer is selected from the group consisting of β″-alumina, Na₃Zr₂Si₂PO₁₂, zirconia, yttria stabilized zirconia, and magnesia.

15. The electrochemical cell of claim 14 wherein at least one of the ingredients of said first layer is selected from the group consisting of β″-alumina and Na₃Zr₂Si₂PO₁₂.

16. The electrochemical cell of claim 12 wherein said second layer is selected from the group consisting of silicon carbide, graphite, pure metals, metal alloys, and transition metal oxides of transition metals selected from groups IIIA, IVA, VA, VIA, VIIA, VIIIA, IB, and IIB of the Periodic Table of the Elements, and mixtures and combinations of two or more of these.

17. A method of making a thin-film electrolyte structure and composition comprising an ionically conductive layer and a porous substrate, the methods comprising the steps of:
a) depositing a composition comprising a precursor of the porous substrate via a deposition process onto an electrically conductive, oxidizable substrate material;
b) applying, via electrophoretic deposition, a composition comprising a presursor to the ionically conductive layer to at least a portion of the composition comprising a presursor of the porous substrate, preferably without intermediate drying of the composition comprising a precursor of the porous substrate, thus forming a green structure and composition; and
c) drying and sintering the green structure and composition in an atmosphere comprising oxygen to remove substantially all of the electrically conductive, oxidizable substrate material.

18. The method of claim 17 wherein the ionically conductive layer comprises materials selected from the group consisting of β″-alumina, Na₃Zr₂Si₂PO₁₂, and mixtures thereof.

19. The method of claim 17 wherein the porous substrate is selected from the group consisting of yttria stabilized zirconia, titanium oxide selected from Ti_{N}O_{2N-1} where N ranges from 4-10, tantalum doped-titania, and niobium-doped titania, α-alumina and combinations thereof.

20. The method of claim 17 wherein the atmosphere comprising oxygen is air.

21. The method of claim 17 wherein the electronically conductive, oxidizable substrate is a material that can be burned in an atmosphere comprising oxygen.

22. The method of claim 21 wherein the electronically conductive, oxidizable substrate is graphite.

23. The method of claim 22 wherein the graphite has a pore size ranging from about 5 to about 10 microns.

24. The method of claim 17 wherein the porous substrate is less than 100 microns in thickness.

25. The method of claim 24 wherein the ionically conductive layer is less than 50 microns in thickness.

26. The method of claim 17 wherein the drying and sintering of step (c) occur at temperatures ranging from about 1200° C. to about 1650° C.

27. The method of claim 17 wherein the composition comprising a presursor to the ionically conductive layer comprises β″-alumina having an average particle size ranging from about 0.5 to about 1.0 micron.

28. A product made by the method of claim 17.

29. The product of claim 25 having a shape selected from the group consisting of rod, tube, corrugated sheet, flat plate, I-beam, triangular, prismatic, polygonal, saddle, spherical, and multi-sided pyramidal.

30. An electrochemical cell comprising the product of claim 25.

31. A transportation vehicle comprising the electrochemical cell of claim 30.

32. A transportation vehicle comprising an electrochemical cell of claim 12.

33. A method of making a thin-film electrolyte structure and composition comprising an ionically conductive layer comprising β-alumina and a substrate comprising α-alumina, the method comprising the steps of:
a) depositing a composition comprising α-alumina via a deposition process onto an electrically conductive, oxidizable substrate material, thus forming a composition comprising α-alumina on the substrate;
b) applying, via electrophoretic deposition, a composition comprising β″-alumina to at least a portion of the composition comprising α-alumina, preferably without intermediate drying of the composition comprising α-alumina, thus forming a green structure and composition; and
c) drying and sintering the green structure and composition in an atmosphere comprising oxygen to remove substantially all of the electrically conductive, oxidizable substrate material.

34. A transportation vehicle comprising an electrochemical cell, the electrochemical cell connected electrically to a motor, the electrochemical cell comprising an anode material comprising liquid sodium, a cathode material comprising liquid sulfur/polysulfide mixture, and a thin-film electrolyte, the thin-film electrolyte selected from the group consisting of
a) a structure having a first layer comprising a mixture of β″-alumina and Na₃Zr₂Si₂PO₁₂, and a second layer comprising graphite; and
b) a structure having a layer of β″-alumina bonded to a layer of α-alumina, the layer of β″-alumina having a thickness less than 50 microns, and the layer of α-alumina having a thickness less than 100 microns.
